(19) United States
(12) Patent Application Publication
(10) Pub. No.: US 2015/0155749 A1
(43) Pub. Date: Jun. 4, 2015

(54) METHOD OF MANUFACTURING A LAMINATED WINDING AND A LAMINATED WINDING

(71) Applicant: VOLVO TRUCK CORPORATION, Göteborg (SE)

(72) Inventor: Conny Högmark, Helsingborg (SE)

(73) Assignee: VOLVO TRUCK CORPORATION, Göteborg (SE)

(21) Appl. No.: 14/409,222

(22) PCT Filed: Jun. 20, 2013
(86) PCT No.: PCT/EP2013/001819

§ 371 Date: Dec. 18, 2014

(30) Foreign Application Priority Data
Jun. 21, 2012 (SE) 1200375-2

(51) Int. Cl. H02K 3/24; H02K 15/04

(52) U.S. Cl. CPC H02K 3/24; H02K 15/0435

(57) ABSTRACT

A method of producing a laminated winding with radial slots for electrical machines includes cutting cuts in a strip where the cuts form the radial slots of the laminated winding, and winding the strip to form the laminated winding. A laminated winding for an electrical machine produced according to the method is also provided.

### TECHNICAL FIELD

The present disclosure relates to method of producing a laminated winding with radial slots for electrical machines and to a laminated winding for an electrical machine produced according to that method.

### TECHNICAL BACKGROUND

Today there is a need for electric machines that for extended periods of time are able to convert several times more power than its continuous specified power, also called nominal power. The nominal power in combination with the cooling method normally determines the weight and space of the machine. Shorter periods of operation at power levels higher than the nominal power are handled by heating of the thermal mass of the machine. This is not least relevant for electrically driven vehicles and hybrid vehicles where the need for several times higher power than the nominal power during a limited time period happens for example in extended acceleration or in longer time driving uphill. In such cases the heating of the thermal mass of the machine may not be enough to handle the extended period of operation time at very high power, even if the machine electromagnetically is able to provide the power, and thus alternative cooling concepts must be used.

Laminated windings may be used in electric machines. Laminated windings are known from i.a. patent U.S. Pat. No. 4,398,112 in which a three quarter winding it is described for which they roll and glue the strip to a cylinder before the slots are made with cutting or milling. This method of production hinders the possibility to feed a cooling medium, such as a gas or liquid, through the winding.

It is known that the method of production in patent U.S. Pat. No. 4,398,112 the three quarter winding has an increased shortcut risk between the winding turns in each slot after the milling or cutting of the slot, and the slot sides thereby needs to be polished.

In patent U.S. Pat. No. 4,398,112 the three quarter winding does not consider the dielectric weakness of a sharp angle at the end of each winding slot that can decrease the breakthrough voltage between the winding and the core.

It is known to cool a winding by using a gas medium such as air flow through the spacing in a winding, and this is described in U.S. Pat. No. 5,331,244 A. The winding design in this document is an air core machine.

A production method with first punching and then winding a strip is a known method for manufacturing the iron core of an electrical machine and is described in documents EP 10 685 A1 and U.S. Pat. No. 3,019,998 A.

There is a need for improving the production method of such laminated windings and for also improving the laminated windings.

### SUMMARY

These and other objects of the disclosure will become apparent from the following description. According to one aspect a method of producing a laminated winding with radial slots for electrical machines is disclosed, the method including cutting cuts in a strip where the cuts form the radial slots of the laminated winding, and winding the strip to form the laminated winding.

The distances between the cuts may be individually calculated so that a desired spacing between individual winding turns is achieved.

The distances between the cuts may be individually calculated so that a desired angle between individual slots can be achieved.

The axial length of the winding may be defined by the width of the strip of the conducting material.

Different cross section areas of the conductor may be used at different sections of the winding.

The step of cutting the cuts may be made such that the cuts are located alternatingly in each longitudinal side of the strip, where distances between adjacent cuts increase with every turn of the laminated winding when a winding diameter of the laminated winding increases, so that a desired radial spacing between individual winding turns of the laminated winding is achieved.

The radial spacing between adjacent winding turns makes it possible to provide for cooling of the laminated winding when in use in an electrical machine. The cooling takes place mainly through convection between the surfaces of the laminated winding and the cooling media.

According to another aspect of the present disclosure a laminated winding for an electrical machine is disclosed, which laminated winding is produced according to the above-mentioned method, wherein a gaseous or liquid cooling media is transported through the distances between the winding turns.

The laminated winding may be for a radial flux electrical motor with an axial flow of the cooling media.

### BRIEF DESCRIPTION OF THE DRAWINGS

In the following the disclosure will be visualized through the accompanying drawings, in which

FIG. 1 is a perspective view of a laminated winding during winding,

FIG. 2 is a partial magnification of a detail of the laminated winding of FIG. 1,

FIG. 3 is a partial top view of a part of the laminated winding of FIG. 1, and

FIG. 4 is a graph showing the cooling effect over time for different current densities and air speeds for the laminated winding of FIG. 1.

### DETAILED DESCRIPTION OF THE DRAWINGS

A non-limiting example of a laminated winding will now be described with reference to the accompanying drawings.

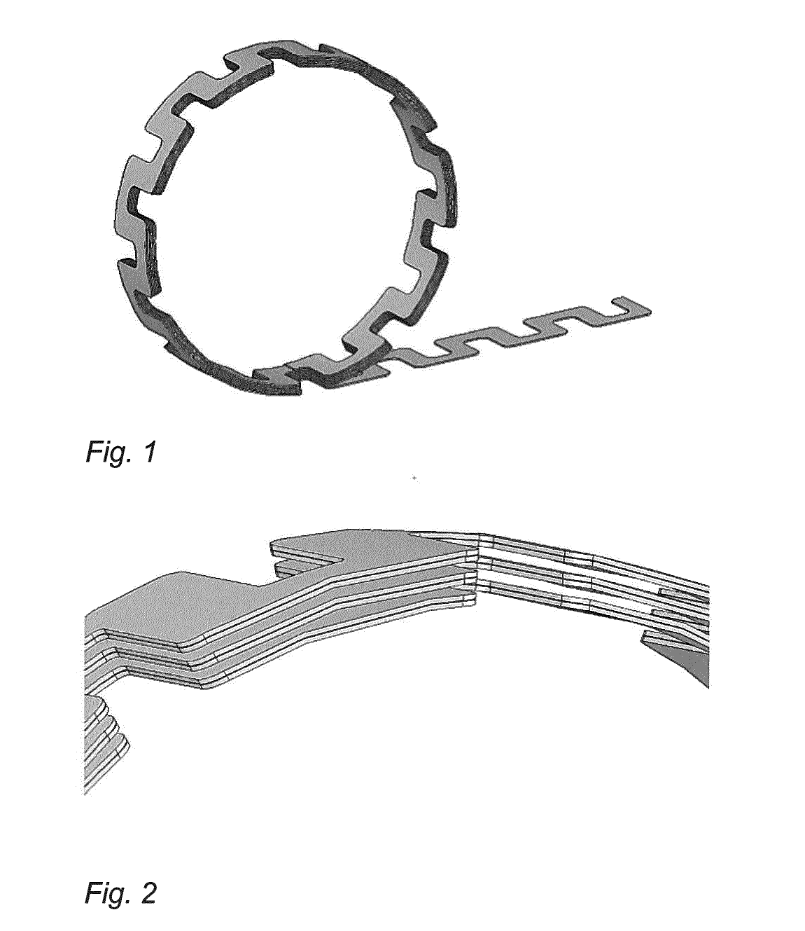

In FIGS. 1 and 2 an example of a laminated winding according to the present disclosure is shown. The laminated winding is made from a strip of a conducting material. The general method of producing the laminated winding is shown in FIG. 1. The structure can be seen in more detail in FIG. 2. The laminated winding is manufactured through making cuts in the strip and then winding the strip on its flat side into a generally cylindrical roll in such a way that individual cuts are arranged in an overlapping manner in the final laminated winding. The strip is hence pre-cut to the winding step. The method step of winding the laminated winding is made such that a distance in radial direction of the cylindrical roll is achieved between each winding turn. In other words, each winding turn is made up of the strip and is located separated from adjacent winding turns by the radial distance. This can be seen in more detail in FIG. 2. The overlapping cuts define the slots in the final laminated winding. The cuts are hence located such that they end up in the laminated winding on top of each other such that the radial slots form a continuous passage in the radial direction of the laminated winding.

The cuts are made alternatingly from either side of the strip in a transversal manner as seen in relation to the extension direction of the strip. The cuts are made with individual distances between them, i.e. with individual distances in the lengthwise direction of the strip, or in other words between adjacent cuts. The reason for doing so is that when the strip is wound up to a final laminated winding, it gives the possibility to control the distance between the winding turns, i.e. it gives the possibility to control the radial distance between the winding turns. The distance between the cuts increases with every turn of the winding when the windings diameter increases, to be able to form the winding slot when the winding is wound up. If the conducting strip with its cuts making up the slots, in contrast to what is disclosed in U.S. Pat. No. 4,398,112, is punched before it is wound up, there is a possibility to incorporate this radial distance between each winding turn. The cost will be at copper fill-factor, i.e. electrical conducting material fill-factor. The gain will be the ability to press the cooling medium through the finished winding and get a more effective cooling inside the winding slot where the losses appear. The cost of conducting fill-factor is not a problem since the laminated winding has a naturally high fill-factor. With this production method there is also the possibility to design where in the windings the cooling is going to be applied by controlling the distance between the cuts to create one or several larger gaps distributed in the winding where the cooling medium is flowing through to cool the winding.

The possibility to get an effective cooling directly in the laminated winding makes it possible to increase the active length of the electric machine by minimizing the winding end turns. This is not possible to do with an ordinary winding made of continuous round conductors. In this disclosure a varying conductor cross section area is accomplished by choosing different area of the conducting cross sections of the winding with e.g. one size of the winding where the cooling is applied and another one in the end turns of the winding.

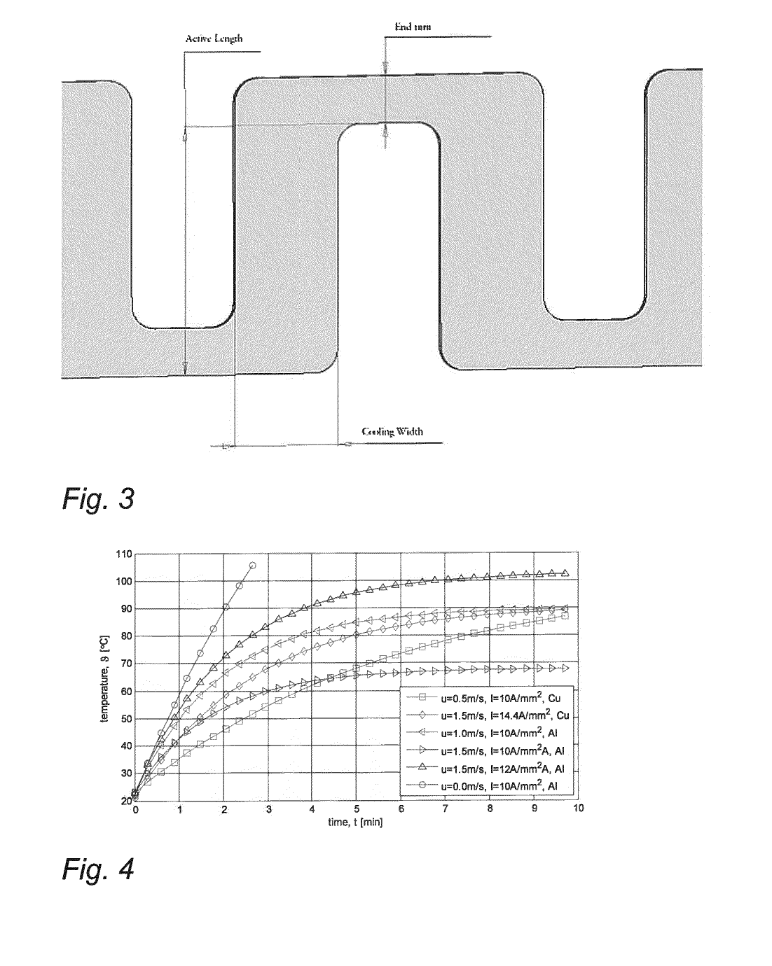

From FIG. 3 it can be gleaned that the cross section area in each location of the laminated winding is represented by the thickness of the strip and the width of the wave like strip, such as cooling width or end turn width. The axial length of the winding is defined by the width of the strip, which in turn is defined by the sum of the active length of the laminated winding and the width of the end turn. The width of the end turn is smaller than the cooling width. The thermal stress in the end turns is increased, but this is not a problem as the heat transportation to the cooling area is fast.

The cooling graphs disclosed in FIG. 4 show winding materials of aluminium and copper, air speeds of 0-1.5 m/s and current densities of 10-14.4 A/mm².

The risk for short-cutting the winding turns, which is described above, can be avoided by removing the burr developed during the punching with brushing or graining before the strip is wound up to a laminated winding. This also saves time and minimizes cost in the production of the laminated winding.

The above-mentioned dielectric weakness of sharp angles at the end of each winding slot may be solved by adding a radius at the end of the winding slot during punching of the strip. This is not as easy to do when cutting or milling an already wound up cylinder as in patent U.S. Pat. No. 4,398,112 due to the risk of harming the winding by flaking up the winding turns.

In contrast to U.S. Pat. No. 5,331,244 A the present disclosure relates to an electric machine having a dense laminated iron core. An iron core would normally hinder the cooling with a radial air flow through the winding except for the end turns. Furthermore placing a fan radially outside the machine would normally severely increase the size of the machine, which machines with the presently disclosed laminated winding do not need.

1. A method of producing a laminated winding with radial slots for electrical machines, the method including:
cutting cuts in a strip where the cuts form the radial slots of the laminated winding, and
winding the strip to form the laminated winding.

2. A method according to 1, wherein the distances between the cuts are individually calculated so that a desired spacing between individual winding turns is achieved.

3. A method according to any one of claim 1 or 2, wherein the distances between the cuts are individually calculated so that a desired angle between individual slots can be achieved.

4. A method according to any one of claim 1, 2 or 3, wherein the axial length of the winding is defined by the width of the strip of the conducting material.

5. A method according to any one of claim 1, 2, 3 or 4, wherein different cross section areas of the conductor are used at different sections of the winding.

6. A method of claim 1, wherein the step of cutting the cuts is made such that the cuts are located alternatingly in each longitudinal side of the strip, where distances between adjacent cuts increase with every turn of the laminated winding when a winding diameter of the laminated winding increases, so that a desired radial spacing between individual winding turns of the laminated winding is achieved.

7. A laminated winding for an electrical machine produced according to any one of claim 2, 3, 4, 5, or 6, wherein a gaseous or liquid cooling media is transported through the distances between the winding turns.

8. A laminated winding according to 7 for a radial flux electrical motor with an axial flow of the cooling media.
